(19) United States
(12) Patent Application Publication
(10) Pub. No.: US 2025/0141964 A1
(43) Pub. Date: May 1, 2025

(54) PHYSIOLOGICAL INFORMATION PROCESSING SYSTEM AND RELAY DEVICE

(71) Applicant: NIHON KOHDEN CORPORATION, Tokyo (JP)

(72) Inventors: Shohei TADA, Tokorozawa-shi (JP); Taku SUZUKI, Tokorozawa-shi (JP); Naohiro OKAMOTO, Tokorozawa-shi (JP)

(73) Assignee: NIHON KOHDEN CORPORATION, Tokyo (JP)

(21) Appl. No.: 18/923,119

(22) Filed: Oct. 22, 2024

(30) Foreign Application Priority Data
Oct. 30, 2023 (JP) 2023-185853

(51) Int. Cl. H04L 67/12; H04L 47/12

(52) U.S. Cl. CPC H04L 67/12; H04L 47/20

(57) ABSTRACT

A physiological information processing system includes a first information processing device configured to process physiological information, a second information processing device, and a relay device configured to control network communication between the first information processing device and the second information processing device. The relay device includes a controller configured to control the network communication between the first information processing device and the second information processing device, based on at least one of first device information included in a packet transmitted from the first information processing device or second device information set through a device information setting unit.

### CROSS-REFERENCE TO RELATED APPLICATIONS

This application is based on and claims priority under 35 USC 119 from Japanese Patent Application No. 2023-185853 filed on Oct. 30, 2023, the entire content of which is incorporated herein by reference.

### TECHNICAL FIELD

The presently disclosed subject matter relates to a physiological information processing system and a relay device.

### BACKGROUND ART

In a medical institution, various information devices including a medical device are used while cooperating with each other in a network environment. Since the medical device is used on a human body, safe system management is required in the network environment.

For example, U.S. Pat. No. 11,558,261B discloses a management system that gives a notification of alarm information in a case where a specific event such as incorrect password input occurs in an encryption protocol for network communication of the medical device.

In recent years, laws and regulations require strengthening the network security of the medical device against an external cyber attack. Specifically, three requirements (confidentiality, authenticity, and integrity) are required for the medical device. In order to meet these requirements, it is necessary to have a function of appropriately protecting network communication against at least a distributed denial of service (DDOS) attack that sends a large number of communication packets at once.

### SUMMARY OF INVENTION

Aspect of non-limiting embodiments of the present disclosure relates to provide a physiological information processing system and a relay device with enhanced network security

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a physiological information processing system including:
a first information processing device configured to process physiological information;
a second information processing device; and
a relay device configured to control network communication between the first information processing device and the second information processing device,
in which the relay device includes a controller configured to control the network communication between the first information processing device and the second information processing device, based on at least one of first device information included in a packet transmitted from the first information processing device or second device information set through a device information setting unit.

According to an aspect of the present disclosure, there is provided a relay device for relaying network communication between a first information processing device and a second information processing device, the first information processing device being configured to process physiological information, the relay device including:
a controller configured to control the network communication between the first information processing device and the second information processing device, based on at least one of first device information included in a packet transmitted from the first information processing device or second device information set through a device information setting unit.

### BRIEF DESCRIPTION OF DRAWINGS

Exemplary embodiment(s) of the present invention will be described in detail based on the following figures, wherein:

FIG. 1 is a configuration diagram of a physiological information processing system according to an embodiment of the presently disclosed subject matter;

FIG. 2 is a block diagram of a relay device;

FIG. 3 is a configuration diagram of a communication packet; and

FIG. 4 is a schematic diagram of a user operation screen for setting device information.

### DESCRIPTION OF EMBODIMENTS

Hereinafter, an embodiment of the presently disclosed subject matter will be described with reference to the drawings.

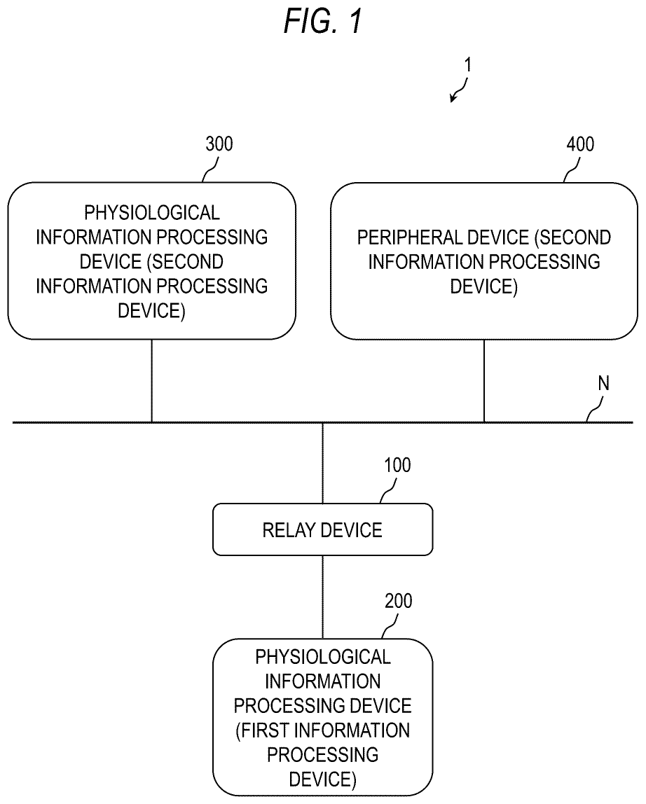

FIG. 1 is a configuration diagram of a physiological information processing system according to an embodiment of the presently disclosed subject matter. As illustrated in FIG. 1, a physiological information processing system 1 can include a relay device 100, physiological information processing devices 200 and 300, and a peripheral device 400. The physiological information processing device 300 and the peripheral device 400 are directly connected to a network N, and the physiological information processing device 200 is connected to the network N via the relay device 100. The network N is, for example, a local area network (LAN), and is implemented by one or both of wired and wireless networks. The communication protocol of the network N may be a general-purpose communication protocol such as transmission control protocol/Internet protocol (TCP/IP), or may be a communication protocol dedicated to the medical field such as digital imaging and communications in medicine (DICOM). The physiological information processing devices 200 and 300 and the peripheral device 400 are configured to transmit and receive communication packets to and from each other using any one of unicast, multicast, and broadcast communication methods.

The physiological information processing devices 200 and 300 are, for example, central monitors, bedside monitors, central units, medical telemeters, and the like, and are medical devices configured to process physiological information. The peripheral device 400 is, for example, a printer, a server, or the like, and is not a medical device. Hereinafter, the physiological information processing device 200 is also referred to as a first information processing device, and the physiological information processing device 300 and the peripheral device 400 are collectively referred to as a second information processing device. In this example, the second information processing device has a configuration that can include the physiological information processing device 300 and the peripheral device 400, and may have a configuration that can include only one of the physiological information processing device 300 and the peripheral device 400. In this example, the physiological information processing device 300 and the peripheral device 400 are each connected to the network N. Alternatively, a plurality of physiological information processing devices 300 may be connected to the network N, or a plurality of peripheral devices 400 may be connected to the network N. The relay device 100 is a relay configured to control network communication between the first information processing device and the second information processing device. In a case where the first information processing device does not include a monitoring system that relates to the packet communication amount and the packet size of a communication packet, the relay device 100 has a function as the system.

### <Monitoring System for Packet Communication Amount>

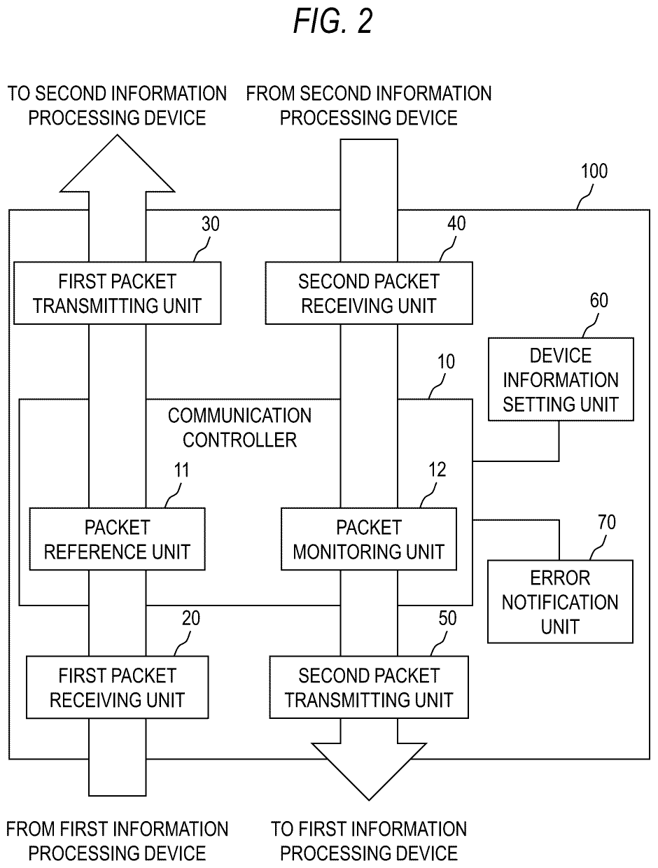

FIG. 2 is a block diagram of the relay device 100. The relay device 100 can include a communication controller 10, a first packet receiving unit 20, a first packet transmitting unit 30, a second packet receiving unit 40, a second packet transmitting unit 50, a device information setting unit 60, and an error notification unit 70. The communication controller 10 can include a packet reference unit 11 and a packet monitoring unit 12. The relay device 100 may include a central processing unit (CPU), a read only memory (ROM), a random access memory (RAM), a hard disk drive (HDD), and the like. The CPU may function as a communication controller 10, a first packet receiving unit 20, a first packet transmitting unit 30, a second packet receiving unit 40, a second packet transmitting unit 50, a packet reference unit 11, and a packet monitoring unit 12.

The first packet receiving unit 20 is configured to receive a communication packet from the physiological information processing device 200, which is the first information processing device. The first packet transmitting unit 30 is configured to transmit the communication packet received by the first packet receiving unit 20 to at least one of the physiological information processing device 300 and the peripheral device 400, which are the second information processing device. The second packet receiving unit 40 is configured to receive the communication packet from at least one of the physiological information processing device 300 and the peripheral device 400. The second packet transmitting unit 50 is configured to transmit the communication packet received by the second packet receiving unit 40 to the physiological information processing device 200.

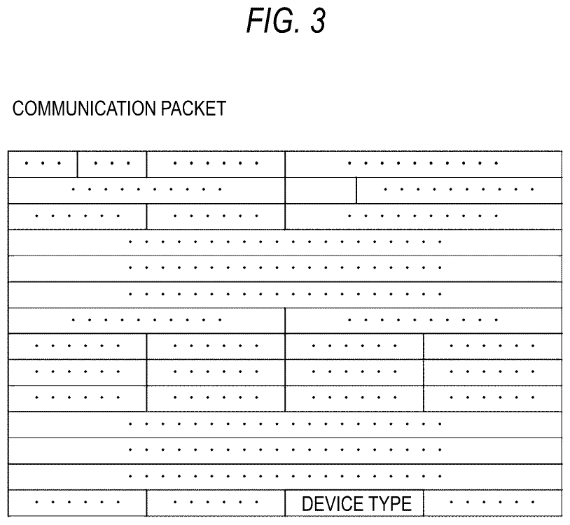

Here, a configuration diagram of a communication packet will be described with reference to FIG. 3. As illustrated in FIG. 3, the communication packet includes a plurality of fields, and one field includes a device type indicating the device information of the first information processing device which is a packet transmission source. The device type indicates, for example, the product name of the first information processing device.

The description returns to FIG. 2. The packet reference unit 11 is configured to refer to the communication packet from the first information processing device received by the first packet receiving unit 20 and to obtain the device type. The communication controller 10 is configured to set a first threshold value for the packet communication amount, based on the device type obtained by the packet reference unit 11.

After the network link is established, the first information processing device and the second information processing device periodically receive the communication packet by broadcast, in order to notify other devices of the own device information and operating state. Therefore, the device type is preferably included in the broadcast communication packet so that the relay device 100 can execute initial setting and update setting of the first threshold value at an appropriate timing.

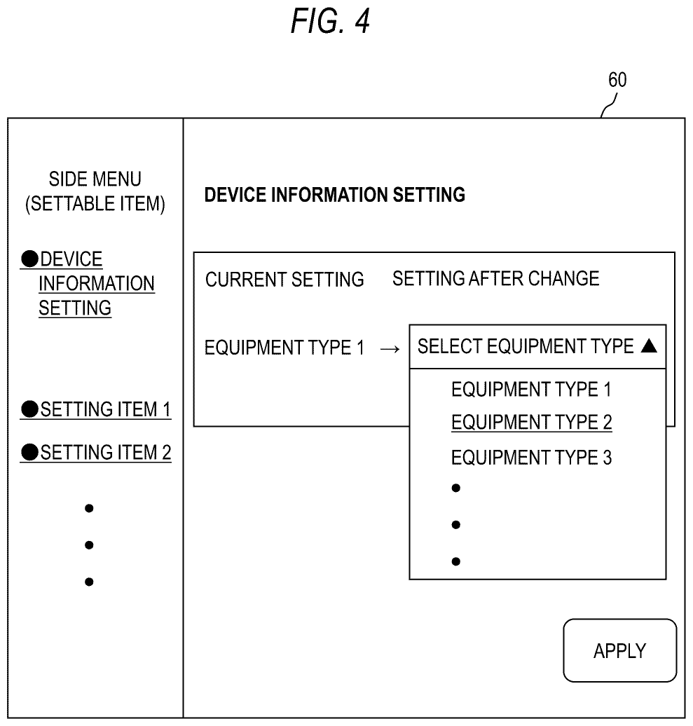

The device information setting unit 60 is an interface configured to allow the user to set the device information of the first information processing device. Specifically, as illustrated in FIG. 4, the equipment type of the first information processing device can be set or changed by a pull down method or the like on a user operation screen for setting the device information. The equipment type indicates, for example, the product name and the model of the first information processing device. Therefore, the equipment type indicates more detailed device information as compared with the device type illustrated in FIG. 3. The communication controller 10 is configured to set the first threshold value for the packet communication amount, based on the equipment type set through the device information setting unit 60. In a case where the communication controller 10 sets the first threshold value based on the device type and sets the first threshold value based on the equipment type, the communication controller 10 may preferentially set the first threshold value based on the equipment type or set, as the first threshold value, the lower threshold value between the first threshold value based on the device type and the first threshold value based on the equipment type.

The packet monitoring unit 12 is configured to constantly monitor the communication packet transmitted from the second information processing device, and to control the network communication based on at least one of the device type and the equipment type set through the device information setting unit 60. Specifically, the packet monitoring unit 12 is configured to determine whether the packet communication amount from the second information processing device to the first information processing device does not exceed the first threshold value within a predetermined time. In a case where the packet communication amount exceeds the first threshold value, the packet communication amount is limited by, for example, cutting off the network communication. In this way, by limiting the excessive packet communication amount, the system down of the first information processing device can be prevented, and the network security against a cyber attack can be strengthened. Since the first threshold value for the packet communication amount is set based on the device information included in the communication packet from the first information processing device, it is possible to set a limit on the packet communication amount that corresponds to the specification of the first information processing device.

In a case where the packet monitoring unit 12 limits the network communication, the error notification unit 70 notifies the user of an error in the network communication. The specific notification method is, for example, error display on a UI operation screen (not illustrated), or audio error notification by a speaker. Accordingly, the user can recognize that the network communication is interrupted due to the excessively large packet communication amount.

### <Monitoring System for Packet Size>

The communication controller 10 is configured to set a second threshold value for the packet size of the communication packet, based on the device type included in the communication packet illustrated in FIG. 3. The communication controller 10 is configured to set the second threshold value for the packet size, based on the equipment type set through the device information setting unit 60. In a case where the communication controller 10 sets the second threshold value based on the device type and sets the second threshold value based on the equipment type, the communication controller 10 may preferentially set the second threshold value based on the equipment type or set, as the second threshold value, the lower threshold value between the second threshold value based on the device type and the second threshold value based on the equipment type.

The packet monitoring unit 12 is configured to constantly monitor the packet size of the communication packet transmitted from the second information processing device. Specifically, the packet monitoring unit 12 is configured to determine whether the packet size of the packet communication from the second information processing device to the first information processing device does not exceed the second threshold value. In a case where the packet size exceeds the second threshold value, the communication packet having an excessively large packet size is limited by, for example, discarding the packet. In this way, by limiting the packet communication having an excessively large packet size, the system down of the first information processing device can be prevented, and the network security against a cyber attack can be strengthened. Since the first threshold value for the packet communication amount is set based on the device information included in the communication packet from the first information processing device, it is possible to set a limit on the packet communication amount that corresponds to the specification of the first information processing device.

In a case where the packet monitoring unit 12 limits the communication packet, the error notification unit 70 notifies the user of an error in the packet size. The specific notification method is, for example, error display on a UI operation screen, or audio error notification by a speaker. Accordingly, the user can recognize that the communication packet is discarded due to the excessively large packet size.

As described above, the physiological information processing system and the relay device according to the embodiment of the presently disclosed subject matter can prevent the system down of the first information processing device by limiting the excessively large packet communication amount and packet size, and can strengthen the network security against a cyber attack. Since the threshold value for the packet communication amount and the packet size is set based on the device information included in the communication packet from the first information processing device, it is possible to set a limit on the packet communication amount and the packet size that correspond to the specification of the first information processing device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The processing of the physiological information processing system 1 according to the present embodiment can be implemented as a computer program that operates in the relay device 100. That is, the relay device 100 can include a processor such as a CPU and a memory.

The program is stored in a non-transitory computer-readable medium and can be read by a computer. Examples of the non-transitory computer-readable medium include a magnetic recording medium, a magneto-optical recording medium, a CD-ROM, a CD-R, a CD-R/W, and a semi-conductor memory (including an EPROM and a flash ROM). The program may be read by a computer using various types of temporary computer-readable media. Examples of the temporary computer-readable medium include an electric signal, an optical signal, and an electromagnetic wave. The temporary computer-readable medium can supply a program to the computer via a wired communication path such as an electric wire and an optical fiber or a wireless communication path.

What is claimed is:

1. A physiological information processing system comprising:
a first information processing device configured to process physiological information;
a second information processing device; and
a relay device configured to control network communication between the first information processing device and the second information processing device,
wherein the relay device includes a controller configured to control the network communication between the first information processing device and the second information processing device, based on at least one of first device information included in a packet transmitted from the first information processing device or second device information set through a device information setting unit.

2. The physiological information processing system according to claim 1,
wherein the controller is configured to limit a packet communication amount between the first information processing device and the second information processing device, based on at least one of the first device information or the second device information.

3. The physiological information processing system according to claim 2,
wherein the controller is configured to set a first threshold value for the packet communication amount, based on at least one of the first device information or the second device information, and
in a case where the packet communication amount between the first information processing device and the second information processing device exceeds the first threshold value within a predetermined time, the controller cuts off the network communication.

4. The physiological information processing system according to claim 3,
wherein the relay device includes an error notification unit configured to, in a case where the controller cuts off the network communication, give a notification of an error in the network communication.

5. The physiological information processing system according to claim 1,
wherein the controller is configured to set a second threshold value for a packet size, and
in a case where a packet size of the packet exceeds the second threshold value, the controller discards the packet transmitted between the first information processing device and the second information processing device.

6. The physiological information processing system according to claim 1,
wherein the second information processing device is configured to process physiological information.

7. A relay device for relaying network communication between a first information processing device and a second information processing device, the first information processing device being configured to process physiological information, the relay device comprising:
a controller configured to control the network communication between the first information processing device and the second information processing device, based on at least one of first device information included in a packet transmitted from the first information processing device or second device information set through a device information setting unit.
